(19) United States
(12) Patent Application Publication
(10) Pub. No.: US 2006/0194133 A1
(43) Pub. Date: Aug. 31, 2006

(54) Magnetic one-component toner and magnetic one-component development method

(75) Inventor: Toru Takatsuna, Osaka (JP)

Correspondence Address: HOGAN & HARTSON L.L.P., 500 S. GRAND AVENUE, SUITE 1900, LOS ANGELES, CA, 90071-2611, US

(73) Assignee: KYOCERA MITA CORPORATION

(21) Appl. No.: 11/365,356

(22) Filed: Feb. 28, 2006

(30) Foreign Application Priority Data
Feb. 28, 2005 (JP) 2005-53954

(51) Int. Cl. G03G 9/083

(52) U.S. Cl. 430/106.1; 430/122

(57) ABSTRACT

The magnetic one-component toner of the present invention is used for a developing device having a stainless-steel development sleeve and satisfies the following formulas (i), (ii), (iii) and (iv). The magnetic one-component development is to develop by using the magnetic one-component toner and rotating a stainless-steel development sleeve at a circumferential velocity of not less than 360 mm/second. Thereby, it is possible to inhibit the occurrence of layer irregularity.

$$\begin{matrix}A ≦ 11 & ( i ) \\ 4 ≦ B & ( ii ) \\ 0.4 ≦ \frac{B}{A} ≦ 0.8 & ( iii ) \\ A \times C ≦ 800 & ( iv )\end{matrix}$$

wherein A represents a frictional charge amount (μC/g) after agitating 5 parts by weight of magnetic one-component toner and 95 parts by weight of non-coated ferrite carrier for one minute, B represents a frictional charge amount (μC/g) after agitating 5 parts by weight of magnetic one-component toner and 95 parts by weight of non-coated ferrite carrier for 30 minutes, and C represents a passage rate of toner (%).

Priority is claimed to Japanese Patent Application No. 2005-53954 filed on Feb. 28, 2005, the disclosure of which is incorporated by reference in its entirety.

### BACKGROUND OF THE INVENTION

1. Field of the Invention

The present invention relates to a magnetic one-component toner and a magnetic one-component development method that are used in electrophotography method.

2. Description of Related Art

Development system in electrophotography method can be divided largely into one-component development system and two-component development system. A developing device using a magnetic one-component developer is disclosed, for example, in Japanese Unexamined Patent Publication No. 57-66455. A development sleeve used for the developing device is obtained, for example, by molding a metal, its alloy or its compound into a cylindrical shape and carrying out surface treatment through electrolysis, blast, filing or the like so as to have a given surface roughness. As a substrate material of development sleeve in general, stainless steel, aluminum and nickel proposed in Japanese Unexamined Patent Publication No. 57-66455 are widely used. Among these, a stainless-steel development sleeve has good resistance to wear and is preferably used in terms of improving the durability of an image forming apparatus.

In such magnetic one-component development method, since there is no carrier, chargeability of toner is very important. In Japanese Unexamined Patent Publication No. 2003-307876, by controlling the frictional charge amount between a toner and a non-coated ferrite carrier within a certain range, the chargeability of toner during printing can be stabilized and image density can be stabilized over a long period of time.

However, according to the development method described in Japanese Unexamined Patent Publication No. 2003-307876, the problem is that when stainless steel having good resistance to wear is used as a substrate material of development sleeve, because of its strong force to provide chargeability, extremely highly charged toner appears, resulting in an uneven thin layer caused by the aggregation of toner, that is, layer irregularity. Moreover, as an image forming apparatus using the above development method becomes higher-speed, a phenomenon of layer irregularity is more likely to occur. The layer irregularity causes such problems as wavelike distorted images or occurrence of fog.

### SUMMARY OF THE INVENTION

The advantage of the present invention is to provide a magnetic one-component toner and a magnetic one-component development method that makes it possible to inhibit the occurrence of layer irregularity in case of using a fast-rotating stainless-steel development sleeve.

After being dedicated to research to solve the above problem, the present inventor has achieved the present invention, finding the fact that if a magnetic one-component toner having a certain frictional charge amount and flowability is used, it is possible to inhibit the occurrence of layer irregularity even in a high-speed stainless-steel development sleeve.

In other words, the magnetic one-component toner of the present invention is used for a developing device having a stainless-steel development sleeve and satisfies the following formulas (i), (ii), (iii) and (iv).

$$\begin{matrix}A ≦ 11 & ( i ) \\ 4 ≦ B & ( ii ) \\ 0.4 ≦ \frac{B}{A} ≦ 0.8 & ( iii ) \\ A \times C ≦ 800 & ( iv )\end{matrix}$$

(In the above formulas, A represents a frictional charge amount (μC/g) after agitating 5 parts by weight of magnetic one-component toner and 95 parts by weight of non-coated ferrite carrier for one minute. B represents a frictional charge amount (μC/g) after agitating 5 parts by weight of magnetic one-component toner and 95 parts by weight of non-coated ferrite carrier for 30 minutes. C represents a passage rate of toner (%) calculated by the following formula (v).)

$$Passage rate of toner ( \% ) = \frac{Toner amount passed through a sieve ( g )}{5 ( g )} \times 100 \qquad ( v )$$

(In the above formula, Toner amount passed through a sieve (g) is measured by using a powder tester (rheostat scale: 2) and passing 5 g of magnetic one-component toner through a 140-mesh vibrating sieve for 30 seconds.)

The magnetic one-component development method of the present invention is the method to carry out development by using a magnetic one-component toner and rotating a stainless-steel development sleeve at a circumferential velocity of not less than 360 mm/second. The above-mentioned magnetic one-component toner satisfies the above formulas (i), (ii), (iii) and (iv).

According to the present invention, since toner charge rise and flowability have proper relationship, the use of a fast-rotating stainless-steel development sleeve makes it possible to form a thin layer stably and inhibit the occurrence of layer irregularity. If the occurrence of layer irregularity is inhibited in this environment of use, highly durable stainless steel can be used as a development sleeve. Thereby, a developing device can have a longer life, and an image forming apparatus having good durability can be obtained. In addition, according to the present invention, it is possible to inhibit the occurrence of layer irregularity in the environment of low temperature and low humidity. Also, thanks to high charging stability, it is possible to attain high image density in case of forming an image in the environment of high temperature and high humidity.

### BRIEF DESCRIPTION OF THE DRAWINGS

FIG. 1 is a schematic illustration showing one example of an image forming apparatus in which the magnetic one-component development method of the present invention can be used.

### DETAILED DESCRIPTION OF PREFERRED EMBODIMENTS

<Magnetic One-Component Toner>

First, the magnetic one-component toner of the present invention (hereinafter, referred to as “toner”) will be described. The toner of the present invention satisfies the following formulas (i) to (iv).

$$\begin{matrix}A ≦ 11 & ( i ) \\ 4 ≦ B & ( ii ) \\ 0.4 ≦ \frac{B}{A} ≦ 0.8 & ( iii ) \\ A \times C ≦ 800 & ( iv )\end{matrix}$$

In the above formulas, A represents a frictional charge amount (μC/g) after agitating 5 parts by weight of toner and 95 parts by weight of non-coated ferrite carrier for one minute. B represents a frictional charge amount (μC/g) after agitating 5 parts by weight of toner and 95 parts by weight of non-coated ferrite carrier for 30 minutes. These frictional charge amounts can be figured out, for example, by putting 5 g of toner and 95 g of non-coated ferrite carrier (“FK-150” by Powdertech Co., Ltd., particle size: 90 μm) into a 20 ml polypropylene container, agitating them with a rocking mixer or a ball mill for a given period of time and measuring the charge amount with a charge measuring instrument. In the above formulas, C represents a passage rate of toner (%) calculated by the following formula (v).

$$Passage rate of toner ( \% ) = \frac{Toner amount passed through a sieve ( g )}{5 ( g )} \times 100 \qquad ( v )$$

Passage rate of toner (%) in the above formula (v) can be figured out by using a powder tester (rheostat scale: 2), passing 5 g of toner through a 140-mesh vibrating sieve for 30 seconds and measuring the toner amount (g) passed through the sieve. In other words, it can be considered that as the value C becomes larger, toner has better flowability.

The value A in the above formulas represents a frictional charge amount after agitating toner and non-coated ferrite carrier for one minute. This value is an indicator of the initial charge amount of toner and it is not more than 11, preferably, 4 to 11 in the present invention. On the other hand, when the value is more than 11, extremely highly charged toner appears, leading to layer irregularity.

The value B in the above formulas represents a frictional charge amount after agitating toner and non-coated ferrite carrier for 30 minutes. In the present invention, this value is not less than 4, preferably, 4 to 10. By contrast, when the value is less than 4, it is difficult to properly charge toner, leading to a decline in image density.

The value B/A in the above formulas is an indicator of toner charge-up tendency. When the value is more than 0.8, layer irregularity occurs. Meanwhile, when the value B/A is less than 0.4, electric charge leaks too much, leading to a decline in density in the environment of high temperature and high humidity.

The value A×C in the above formulas is an indicator of the initial charge amount and flowability of toner. In the present invention, this value is not more than 800, preferably, 400 to 800. Meanwhile, when this value is more than 800, layer irregularity occurs.

The above values, A, B and C can be controlled, for example, by selecting the property of magnetic powder (type, shape, particle size, surface treatment etc.), the amount of added magnetic powder, the property of surface treatment agent for toner (chargeability, specific surface etc.) and the amount of added surface treatment agent. Specifically, the value A can be adjusted, for example, by the type or added amount of surface treatment agent. The value B can be adjusted by the amount of added charge control agent, the shape of magnetic powder and the like. The value C can be adjusted by the type of surface treatment agent, surface treatment time or the like.

<Toner Production Method>

The toner of the present invention can be produced by a well-known method in itself such as pulverization classification method, melting granulation method, spray granulation method and suspension/emulsion polymerization method. Particularly, in terms of production equipment and productivity, pulverization classification method can be preferably used.

In pulverization classification method, first, toner composition is prepared by adding a charge control agent, a release agent or the like to a binder resin, a coloring agent and magnetic powder, when needed. Next, the toner composition is pre-mixed with a Henschel mixer or a V-shaped mixer, and then melted and kneaded with a melting and kneading device such as a biaxial extrusion machine. After the melted and kneaded composition is cooled, it is coarsely ground, pulverized and, if necessary, classified to obtain toner particles having a given particle size distribution. Subsequently, depending on needs, the obtained toner particles undergo surface treatment with a surface treatment agent. Thus, a toner can be obtained.

The above binder resin is not especially limited and it is exemplified by thermoplastic resins such as styrene-acrylic resin, polyester resin, polyacrylic resin, polyethylene resin, polypropylene resin, polyvinyl chloride resin, polyamide resin, polyurethane resin, polyvinyl alcohol resin, vinyl ether resin, N-vinyl resin and styrene-butadiene resin. As a matter of course, if required, another resin can be used together with these resins or a combination of two or more kinds of these resins can be used.

A monomer for the above styrene-acrylic resin matrix is exemplified by styrene, styrene derivatives such as α-methylstyrene, p-methylstyrene, p-t-butylstyrene, p-chlorostyrene and hydroxystyrene, and (meth)acrylic acid ester such as methacrylic acid, methyl (meth)acrylate, ethyl (meth)acrylate, propyl (meth)acrylate, butyl (meth)acrylate, glycidyl (meth)acrylate, methoxyethyl (meth)acrylate, propoxyethyl (meth)acrylate, methoxydiethylene glycol (meth)acrylate, ethoxydiethylene glycol (meth)acrylate, benzyl (meth)acrylate, cyclohexyl (meth)acrylate, tetrahydrofurfuryl (meth)acrylate, (meth)acrylonitrile, (meth)acrylamide, N-methylol (meth)acrylamide, ethyleneglycol di(meth)acrylate, 1,3-butyleneglycol di(meth)acrylate, 1,4-butanediol di(meth)acrylate and trimethylolethane tri(meth)acrylate.

The mixture of the above various monomers is polymerized through any method such as solution polymerization, mass polymerization, emulsion polymerization and suspension polymerization, and can be used as a binder resin in the present invention. Examples of a well-known polymerization initiator that can be used for the polymerization include acetyl peroxide, decanoyl peroxide, lauroyl peroxide, benzoyl peroxide, azobisisobutyronitrile, 2,2′-azobis-2,4-dimethyl valeronitrile and 2,2′-azobis-4-methoxy-2,4-dimethyl valeronitrile. It is preferable to use 0.1 to 15% by weight of polymerization initiator to the total weight of monomers.

The above polyester resin is obtained mainly through condensation polymerization of polyhydric carboxylic acids and polyhydric alcohols. The polyhydric carboxylic acids are exemplified by aromatic polyhydric carboxylic acid such as phthalic acid, isophthalic acid, terephthalic acid, succinic acid, 1,2,4-benzene tricarboxylic acid, 2,5,7-naphthalene tricarboxylic acid, 1,2,4-naphthalene tricarboxylic acid and pyromellitic acid; aliphatic dicarboxylic acid such as maleic acid, fumaric acid, succinic acid, adipic acid, sebacic acid, malonic acid, azelaic acid, mesaconic acid, citraconic acid and glutaconic acid; alicyclic dicarboxylic acid such as cyclohexane dicarboxylic acid and methyl nadic acid; anhydrides of these carboxylic acids and lower alkyl ester. One or a combination of two or more of these is used.

The content of a trivalent or polyvalent component depends on the degree of cross-linking, and its added amount may be adjusted in order to obtain a desired degree of cross-linking. Generally, the content of a trivalent or polyvalent component is preferably not more than 15 mol %.

The polyhydric alcohols used for polyester resin are exemplified by alkylene glycols such as ethylene glycol, 1,2-propylene glycol, 1,3-propylene glycol, 1,4-butanediol, 1,4-butenediol, neopentyl glycol, 1,5-pentane glycol and 1,6-hexane glycol; alkylene ether glycols such as diethylene glycol, triethylene glycol, dipropylene glycol, polyethylene glycol, polypropylene glycol and polytetramethylene glycol; alicyclic polyhydric alcohols such as 1,4-cyclohexane dimethanol and hydrogenated bisphenol A; bisphenols such as bisphenol A, bisphenol F and bisphenol S; and alkylene oxides of bisphenols. One or a combination of two or more of these can be used.

For the purpose of adjusting molecular weight and controlling reaction, if necessary, monocarboxylic acid and monoalcohol can be used. Examples of monocarboxylic acid include benzoic acid, paraoxybenzoic acid, toluenecarboxylic acid, salicylic acid, acetic acid, propionic acid and stearic acid. Examples of monoalcohol include benzyl alcohol, toluene-4-methanol and cyclohexanemethanol.

The binder resin preferably has a glass transition temperature of 54 to 62° C. When the glass transition temperature is less than 54° C., the binder resin may possibly be hardened in a developing device or a toner cartridge. On the other hand, when the glass transition temperature is over 62° C., in some cases, toner cannot be sufficiently fixed on an image transferring medium such as paper.

Since magnetic powder makes color of toner black in a magnetic toner, in case of using as black toner, in general, it is not necessary to use coloring agents. However, in order to reinforce coloring, carbon black such as acetylene black, lamp black and aniline black may be dispersed and mixed in toner particles. In this case, the content of a coloring agent is preferably 0.1 to 10 parts by weight to 100 parts by weight of binder resin.

Examples of magnetic powder include ferrosoferric oxide (Fe₃O₄), iron sesquioxide (γ-Fe₂O₃), zinc iron oxide (ZnFe₃O₄), yttrium iron oxide (Y₃Fe₅O₁₂), cadmium iron oxide (CdFe₂O₄), gadolinium iron oxide (Gd₃Fe₅O₁₂), copper iron oxide (CuFe₂O₄), lead iron oxide (PbFel₂O₁₉), nickel iron oxide (NiFe₂O₄), neodymium iron oxide (NdFeO₃), barium iron oxide (BaFe₁₂O₁₉), magnesium iron oxide (MgFe₂O₄), manganese iron oxide (MnFe₂O₄), lanthanum iron oxide (LaFeO₃), iron powder (Fe), cobalt powder (Co) and nickel powder (Ni). Especially preferable magnetic powder is particulate ferrosoferric oxide (magnetite). The magnetite preferably has a shape of (regular) octahedron and a mean particle size of 0.05 to 1.0 μm. The magnetite particle may undergo surface treatment with a silane coupling agent, a titanium coupling agent or the like. The content of magnetic powder may be 30 to 150 parts by weight, preferably, 50 to 90 parts by weight to 100 parts by weight of binder resin.

As for charge control agent, a well-known charge control agent can be applied. Examples of a positively chargeable charge control agent include nigrosine dye, aliphatic acid modified nigrosine dye, aliphatic acid modified nigrosine dye containing a carboxyl group, quaternary ammonium salt, amine compound and organic metallic compound.

As a release agent, various waxes, low-molecular-weight olefin resin or the like can be used. Examples of waxes include polyhydric alcohol ester of aliphatic acid, higher alcohol ester of aliphatic acid, alkylenebis aliphatic acid amide compound and natural wax. Examples of low-molecular-weight olefin resin include polypropylene, polyethylene and propylene-ethylene copolymer which have a number average molecular weight of 1,000 to 10,000, especially, 2,000 to 6,000.

In order to adjust the charge controllability and flowability of toner, examples of a surface treatment agent include inorganic fine powder such as silica, alumina, titanium oxide, zinc oxide, magnesium oxide and calcium carbonate; organic fine powder such as polymethyl methacrylate; and aliphatic acid metal salt such as zinc stearate. One or a combination of two or more of these can be used together. The amount of added surface treatment agent is preferably 0.1 to 2.0% by weight per toner particle. The surface treatment agent and toner particles can be mixed, using a Henschel mixer, a V-shaped mixer, a Turbula mixer, a hybridizer and the like.

To obtain a high quality image, preferably, the above-mentioned toner has a volume center particle size of 5.0 to 12.0 μm.

<Magnetic One-Component Development Method>

The magnetic one-component development method of the present invention is the method to carry out development by using the above-mentioned magnetic one-component toner and a development sleeve made of stainless steel and rotating the development sleeve at a circumferential velocity of not less than 360 mm/second. With reference to a drawing, the magnetic one-component development method of the present invention and one example of image forming apparatuses that can employ this method will be described below.

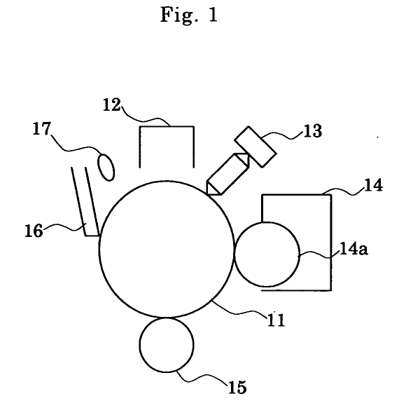

FIG. 1 is a schematic illustration showing the periphery of a photoreceptor of an image forming apparatus that can employ the magnetic one-component development method of the present invention. In the image forming apparatus, a positively charged amorphous silicon (a-Si) photoreceptor drum 11 is used as a latent image carrier. A charging device 12, an exposing device 13, a developing device 14, a transfer roller 15, a cleaning blade (cleaning device) 16 and an electricity removing device 17 are disposed around the a-Si photoreceptor drum 11.

In the image forming apparatus, the a-Si photoreceptor drum 11 is charged by the charging device 12, and an electrostatic latent image is formed on the photoreceptor drum 11 through exposure by light signals that are converted based on print data. Meanwhile, in the developing device 14, toner is transported by rotating a development sleeve 14a that is disposed opposite to the photoreceptor drum 11. The toner to be transported goes through between a magnetic blade (not shown in the drawing) and the development sleeve 14a. Thereby, a toner thin layer is formed on the surface of the development sleeve 14a. The toner thin layer supplies toner to the photoreceptor drum 11, and the electrostatic latent image formed on the photoreceptor drum 11 is developed.

The developed toner image is transferred to a transfer medium (e.g. paper) by the transfer roller 15. On the other hand, toner (waste toner) which remains on the surface of the photoreceptor drum 11 without being transferred to the transfer medium is removed by the cleaning blade 16. On the surface of the photoreceptor drum 11 where waste toner is removed, residual image charges are removed by the electricity removing device 17.

In the present invention, stainless steel (SUS) is used as a material of the development sleeve 14a. The use of SUS as a material of the development sleeve 14a increases durability. Specific examples of SUS include SUS303, SUS304, SUS305 and SUS316.

To obtain a higher-speed image forming apparatus, the development sleeve 14a rotates at a circumferential velocity of not less than 360 mm/second, preferably, 360 to 800 mm/second. Even in this high-speed development sleeve 14a, the use of toner satisfying the above formulas (i) to (iv) makes it possible to form a toner thin layer stably and inhibit the occurrence of layer irregularity. In particular, it is helpful in the environment of low temperature and low humidity (room temperature 5° C./relative humidity 10% to room temperature 10° C./relative humidity 20%) where layer irregularity is apt to occur. In addition, it is possible to attain high image density in the environment of high temperature and high humidity (room temperature 30° C./relative humidity 70% to room temperature 35° C./relative humidity 85%).

As the charging device 12, for example, a scorotron charger can be used. The scorotron charger consists of a shield case, a corona wire, a grid and so on. It is preferable to set a charged width to 10 to 13 mm in a circumferential direction and 240 to 245 mm in a drum shaft direction and set the distance between a corona wire and a grid to 5 to 6.5 mm. In addition, the distance between a grid and the photoreceptor drum 11 may be 0.4 to 0.8 mm. When the distance is less than 0.4 mm, spark discharge may occur. When it is over 0.8 mm, charging capacity may be lowered.

The transfer roller 15 contacts the photoreceptor drum 11. Preferably, the transfer roller 15 is rotated by drive, keeping a difference in linear speed 3 to 5% compared to the photoreceptor drum 11. The difference of less than 3% in linear speed may reduce transferability and cause a void in a printed image, while the difference of over 5% in linear speed may cause a large slip in the transfer roller 15 and the photoreceptor drum Hand increase jitter.

As a cleaning device for the surface of the photoreceptor drum 11, for example, a cleaning blade 16 can be used. The cleaning blade 16 is disposed on the downstream side from the transfer roller 15 in a rotating direction of the photoreceptor drum 11, and its tip touches the photoreceptor drum 11. This enables the removal of waste toner which remains on the surface of the photoreceptor drum 11 without being transferred to the transfer medium.

The cleaning blade 16 is preferably an elastic blade with elasticity. Thereby, it is possible to prevent the surface of the photoreceptor drum 11 from being scratched. Examples of an elastic material include urethane rubber, silicon rubber and elastic resin. The cleaning blade 16 can be obtained either by molding the above elastic material into a blade-like shape or attaching the elastic material to the tip of a metal blade and so on.

The present invention will be described in detail, referring to examples and comparative examples. It is understood, however, that the examples are for the purpose of illustration and the present invention is not to be regarded as limited to any of the specific materials or condition therein.

### EXAMPLES

### Examples

<Preparation of Toner>

Toners 1 to 9 were prepared through the methods below.

[Toner 1]

The following materials for preparing toner were mixed in a Henschel mixer (by Mitsui Miike Kogyo), kneaded with a biaxial extrusion machine (“PCM-30” by Ikegai Ltd.), subsequently ground with an air volume of 4.2 m³/minute using a Turbo mill (by Turbo Kogyo Co., Ltd.) and then classified with an Alpine classifier to obtain toner particles having a mean particle size of 6.8 μm.

(Materials for Preparing Toner)

Polyester resin (acid value=5.6, melting point 120° C.): 100 parts by weight
Magnetic powder A (magnetite, octahedron, mean particle size=0.20 μm, specific surface (BET)=7.1 m 1 g, saturated magnetization (σs)=83.5 Am²/g, remanent magnetization (σr)=12.1 Am2/g): 80 parts by weight
Nigrosine dye (“N01” by Orient Chemical Industries, Ltd.): 2 parts by weight
Charge control resin (styrene-acrylic resin having quaternary ammonium salt as a functional group): 10 parts by weight
Wax (“Yumex 100TS” by Sanyo Chemical Industries, Ltd.): 3 parts by weight

By adding the following surface treatment agent to the toner particles so obtained and mixing them in a Henschel mixer (by Mitsui Miike Kogyo) for four minutes, toner 1 was obtained.

(Surface Treatment Agent)

Silica fine particles A (“REA200” by Nippon Aerosil Co., Ltd., particle size: about 17 nm as a primary particle): 0.6% by weight to toner particles
Titanium oxide fine particles A (mean particle size 0.5 μm, frictional charge amount with carrier: 5 μC/g): 1.2% by weight to toner particles

“Frictional charge amount with carrier” in titanium oxide fine particles A represents a charge amount that was measured by a charge measuring instrument (Q/M meter) when 1 g of titanium oxide and 99 g of non-coated ferrite carrier (“FK-150” by Powdertech Co., Ltd., particle size 90 μm) were put into a 100 ml polypropylene container and agitated for 30 minutes with a rocking mixer.

[Toner 2]

The magnetic powder B and titanium oxide fine particles B below were respectively substituted for the magnetic powder A and the titanium oxide fine particles A. Except for this, toner 2 was prepared in the same manner as the above toner 1.
Magnetic powder B (magnetite, sphere, mean particle size=0.21 μm, BET=8.9 m²/g, σs=82.7 Am²/g, σr=5.9 Am2/g): 80 parts by weight
Titanium oxide fine particles B (mean particle size 0.5 μm, frictional charge amount with carrier: 20 μC/g): 1.2% by weight to toner particles [Toner 3]

Except that an air volume was set to 3 m³/minute during grinding by a Turbo mill, toner 3 was prepared in the same manner as the above toner 1. Reduction in air volume enables a rounder shape than toner 1 and improves the flowability of toner.

[Toner 4]

Instead of the surface treatment agent shown in the method of preparing toner 1, the following surface treatment agent was used. Except for this, toner 4 was prepared in the same manner as the above toner 1.

(Surface Treatment Agent)

Silica fine particles A: 0.5% by weight to toner particles
Silica fine particles B (“NA50H” by Nippon Aerosil Co., Ltd., particle size: about 50 nm as a primary particle): 0.5% by weight to toner particles
Titanium oxide fine particles A: 1.2% by weight to toner particles [Toner 5]

Except that mixture in a Henschel mixer was carried out for two minutes after adding the surface treatment agent to the obtained toner particles, toner 5 was prepared in the same manner as the above toner 1.

[Toner 6]

Except that mixture in a Henschel mixer was carried out for six minutes after adding the surface treatment agent to the obtained toner particles, toner 6 was prepared in the same manner as the above toner 1.

[Toner 7]

Except that the magnetic powder B was used instead of the magnetic powder A, toner 7 was prepared in the same manner as the above toner 1.

[Toner 8]

Instead of the surface treatment agent shown in the method of preparing toner 1, the following surface treatment agent was used. Except for this, toner 8 was prepared in the same manner as the above toner 1.

(Surface Treatment Agent)

Silica fine particles A: 0.4% by weight to toner particles
Silica fine particles B: 1.0% by weight to toner particles
Titanium oxide fine particles A: 1.2% by weight to toner particles
   [Toner 9]

Except that the amount of added charge control resin was 6 parts by weight, toner 9 was prepared in the same manner as the above toner 1.

<Measurement of Frictional Charge Amount and Flowability>

As for toners 1 to 9 obtained in the above, the values A to C in the above formulas (i) to (iv) were measured. The value A was measured as follows. First, 5 g of toner and 95 g of non-coated ferrite carrier (“FK-150” by Powdertech Co., Ltd., particle size: 90 μm) were put into a 20 ml polypropylene container and agitated in a ball mill (revolution: 100 rpm) for one minute. Next, 200 mg of agitated powder was taken out, and the charge amount (μC/g) was measured with a charge measuring instrument (Q/M meter, “210HS-2” by TREK JAPAN), thereby obtaining the value A. The method of measuring charge amount was as follows. A specific amount of agitated powder was put into a cell attached to the Q/M meter and only toner was sucked by passing through a sieve having a sieve opening of 38 μm (made of stainless steel, twill, wire diameter: 0.0027 mm) for 10 seconds. Voltage change on toner which occurred at that time was monitored and the value of “total electric quantity after sucking (μC)/sucked toner amount (g)” was defined as charge amount (μC/g).

The value B was measured in the same way as the above method of measuring A, except that the time of agitation in a ball mill was 30 minutes.

The value C was found out as follows. First, 5 g of toner was weighed, and the weighed toner underwent vibrating sieve under the following conditions, using a powder tester (by Hosokawamicron corp.). Then, the weight of toner (g) passed through the sieve was measured to figure out a passage rate of toner (%), namely, the value C by the above formula (v).

(Conditions for Vibrating Sieve)

Opening of sieve: 106 μm (140 mesh)
Rheostat scale: 2
Sieving time: 30 seconds

Table 1 indicates the values A to C obtained through the above method, the value B/A shown in the formula (iii) and the value A×C shown in the formula (Iv).

TABLE 1

| | A | B | C | | |
|---|---|---|---|---|---|
| Type of toner | (μC/g) | (μC/g) | (%) | B/A | A × C |
| Toner 1 | 7 | 4 | 80 | 0.57 | 560 |
| Toner 2 | 10 | 4 | 75 | 0.40 | 750 |
| Toner 3 | 8 | 6 | 90 | 0.75 | 720 |
| Toner 4 | 11 | 7 | 60 | 0.63 | 660 |
| Toner 5 | 11 | 4 | 85 | 0.36 | 935 |
| Toner 6 | 6 | 5 | 70 | 0.83 | 420 |
| Toner 7 | 11 | 8 | 80 | 0.73 | 880 |
| Toner 8 | 13 | 9 | 50 | 0.69 | 650 |
| Toner 9 | 7 | 3 | 80 | 0.43 | 560 |

<Image Evaluation Test>

### Examples 1 to 4

Any of toners 1 to 4 was installed in a printer LS-9500DN (printing speed 50 sheets of A4 paper per minute, circumferential speed of development sleeve: 368 mm/second) by Kyocera Mita Corp. which adopts magnetic one-component development method and uses stainless steel as a development sleeve. Then, layer irregularity, image density and fog were evaluated.

Since layer irregularity is caused by excessively charged toner, it is very apt to occur in the environment of low temperature and low humidity. In case of blank printing, toner is not replaced and therefore easily causes charge-up and layer irregularity. In the evaluation test for layer irregularity, 10,000 sheets of blank (white) paper were printed in the environment of low temperature and low humidity (room temperature 10° C./relative humidity 15%) and the occurrence of layer irregularity was visually checked. The results are shown in Table 2. The following is a criterion for layer irregularity.

(Criterion for Layer Irregularity)

◯: No layer irregularity is seen on a development sleeve after printing 10,000 sheets of paper.

Δ: Slight layer irregularity is seen on a development sleeve after printing 10,000 sheets of paper.

X: Layer irregularity is seen on a development sleeve during printing.

XX: Layer irregularity is seen on a development sleeve in the initial stage.

As for the evaluation of image density and fog, 10,000 sheets of paper were printed in the environment of high temperature and high humidity (room temperature 35° C./relative humidity 85%) to measure image density and fog. The image density and the fog were measured with a reflection densitometer (“TC-6D” by Tokyo Denshoku Co., Ltd.). The results are shown in Table 2. The following are criteria for image density and fog.

(Criterion for Image Density)

1.4 or more . . . A

Not less than 1.3 to less than 1.4 . . . B

Not less than 1.2 to less than 1.3 . . . C

Less than 1.2 . . . D

(Criterion for Fog)

Less than 0.003 . . . A

Not less than 0.003 to less than 0.008 . . . B

0.008 or more . . . C

### Examples 5 to 8

For evaluation, toners 1 to 4 were installed in a remodeled printer LS-9500DN (printing speed 80 sheets of A4 paper per minute, circumferential speed of development sleeve: 704 mm/second) by Kyocera Mita Corp. which adopts magnetic one-component development method and uses stainless steel as a development sleeve. 10,000 sheets of blank (white) paper were printed in the environment of low temperature and low humidity (room temperature 10° C. /relative humidity 15%) and the occurrence of layer irregularity was visually checked. In addition, 10,000 sheets of paper were printed in the environment of high temperature and high humidity (room temperature 35° C./relative humidity 85%) to measure image density and fog. The results are shown in Table 2.

### Comparative Examples 1 to 5

The test was conducted in the same manner as in Examples 1 to 4, except that toners 5 to 9 were used. The results are shown in Table 2.

TABLE 2

| | | | | | | | | | | Low temperature |
|---|---|---|---|---|---|---|---|---|---|---|
| | | | | | | | | | | and low |
| | | High temperature and high humidity (1) | | | | | | | | humidity (2) |
| | Type | Initial stage | | | | After printing 10,000 sheets of paper | | | | Layer |
| | of toner | Image density | Evaluation | Fog | Evaluation | Image density | Evaluation | Fog | Evaluation | irregularity (3) |
| Example 1 | Toner 1 | 1.340 | B | 0.001 | A | 1.301 | B | 0.001 | A | ◯ |
| Example 2 | Toner 2 | 1.378 | B | 0.000 | A | 1.280 | C | 0.001 | A | ◯ |
| Example 3 | Toner 3 | 1.358 | B | 0.000 | A | 1.350 | B | 0.000 | A | Δ |
| Example 4 | Toner 4 | 1.366 | B | 0.001 | A | 1.347 | B | 0.001 | A | Δ |
| Example 5 | Toner 1 | 1.353 | B | 0.002 | A | 1.330 | B | 0.002 | A | ◯ |
| Example 6 | Toner 2 | 1.385 | B | 0.002 | A | 1.310 | B | 0.001 | A | ◯ |
| Example 7 | Toner 3 | 1.360 | B | 0.001 | A | 1.355 | B | 0.001 | A | Δ |
| Example 8 | Toner 4 | 1.372 | B | 0.001 | A | 1.359 | B | 0.001 | A | Δ |
| Comp. Ex. 1 | Toner 5 | 1.345 | B | 0.003 | B | 1.198 | D | 0.004 | B | XX |
| Comp. Ex. 2 | Toner 6 | 1.329 | B | 0.000 | A | 1.325 | B | 0.000 | A | X |
| Comp. Ex. 3 | Toner 7 | 1.387 | B | 0.000 | A | 1.378 | B | 0.001 | A | X |
| Comp. Ex. 4 | Toner 8 | 1.355 | B | 0.000 | A | 1.350 | B | 0.000 | A | XX |
| Comp. Ex. 5 | Toner 9 | 1.290 | C | 0.001 | A | 1.180 | D | 0.002 | A | ◯ |

(1) Room temp. 35° C., relative humidity 85%
(2) Room temp. 10° C., relative humidity 15%
(3) In the initial stage and after printing 10,000 sheets of paper

The phenomenon of layer irregularity occurs, possibly because toner aggregates due to too highly charged toner. The tendency of layer irregularity occurring is connected to the initial charge amount of toner, the tendency of charge-up and the mobility of toner (flowability of toner) on a development sleeve.

In the formulas (i) to (iv), the initial charge amount of toner is represented by the value A and the tendency of charge-up is represented by the value B/A. The flowability of toner is represented by the value C and a larger value of C shows better flowability. As these values are larger, layer irregularity is more likely to occur.

On the other hand, sustainability of density in the environment of high temperature and high humidity is related to sustainability of toner charge amount. The sustainability of toner charge amount is represented by the values B/A and B. When the value B/A is large, charge retention ability is high and the sustainability of density in the environment of high temperature and high humidity is sufficient, but layer irregularity is likely to occur.

As shown in Tables 1 and 2, toners of Examples 1 to 8 satisfy the above formulas (i) to (iv). Therefore, it is possible to both inhibit the occurrence of layer irregularity and keep a density constant in the environment of high temperature and high humidity.

By contrast, in Comparative Example 1, the surface treatment time for toner was too short, thereby making the value A×C too large. In other words, the initial charge amount and flowability of toner were too sufficient. Thus, layer irregularity occurred in the initial stage. Furthermore, since the value B/A was too small, that means, electric charge leaks too much, density significantly decreased in the environment of high temperature and high humidity.

In Comparative Example 2, because of too long surface treatment time, more treatment agent was buried. Therefore, since the value B/A was large and toner caused charge-up, layer irregularity occurred.

In Comparative Example 3, toner 7 wherein spherical magnetic powder (magnetic powder B) was added instead of magnetic powder A in toner 1 was used. Therefore, since the value A×C was large, that is, the charge amount and flowability of toner were too high, layer irregularity occurred.

In Comparative Example 4, toner 8 wherein silica fine particles B having a large particle size were added was used. The flowability of toner was low, but the initial charge amount was too high (the value A was 13, which was larger than 11). Thus, layer irregularity occurred.

In Comparative Example 5, a too small amount of charge control resin made the value B smaller than 4, namely, the sustainability of charge amount was poor. This led to poor sustainability of density in the environment of high temperature and high humidity.

What is claimed is:

1. A magnetic one-component toner, which is used for a developing device having a stainless-steel development sleeve and satisfies the following formulas (i), (ii), (iii) and (iv),
$$\begin{matrix}A ≦ 11 & ( i ) \\ 4 ≦ B & ( ii ) \\ 0.4 ≦ \frac{B}{A} ≦ 0.8 & ( iii ) \\ A \times C ≦ 800 & ( iv )\end{matrix}$$
wherein A represents a frictional charge amount (μC/g) after agitating 5 parts by weight of magnetic one-component toner and 95 parts by weight of non-coated ferrite carrier for one minute, B represents a frictional charge amount (μC/g) after agitating 5 parts by weight of magnetic one-component toner and 95 parts by weight of non-coated ferrite carrier for 30 minutes, and C represents a passage rate of toner (%) calculated by the following formula (v),
$$Passage rate of toner ( \% ) = \frac{Toner amount passed through a sieve ( g )}{5 ( g )} \times 100 \qquad ( v )$$
wherein Toner amount passed through a sieve (g) is measured by using a powder tester (rheostat scale: 2) and passing 5 g of magnetic one-component toner through a 140-mesh vibrating sieve for 30 seconds.

2. The magnetic one-component toner according to claim 1, which is obtained through pulverization classification method.

3. The magnetic one-component toner according to claim 1, containing magnetite having a shape of octahedron and a mean particle size of 0.05 to 1.0 μm as magnetic powder.

4. A magnetic one-component development method,
wherein development is carried out by using a magnetic one-component toner and rotating a stainless-steel development sleeve at a circumferential velocity of not less than 360 mm/second; and
the magnetic one-component toner according to claim 1 is used as the said magnetic one-component toner.

5. The magnetic one-component development method according to claim 4, wherein the said stainless-steel development sleeve rotates at a circumferential velocity of 360 to 800 mm/second.
